(19) United States
(12) Patent Application Publication
(10) Pub. No.: US 2007/0081319 A1
(43) Pub. Date: Apr. 12, 2007

(54) Backlight module having optical conversion device

(75) Inventors: Wu-Hong Fang, Shenzhen (CN); Ming-Hung Tsai, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/545,936

(22) Filed: Oct. 10, 2006

(30) Foreign Application Priority Data
Oct. 7, 2005 (TW) 94135063

(51) Int. Cl. F21V 9/14; F21V 7/04

(52) U.S. Cl. 362/19; 362/611

(57) ABSTRACT

A backlight module (3) includes a light guide plate (31), a light source (32) and an optical conversion device (33). The light guide plate includes an incident surface (311), an emitting surface (312) adjacent to the incident surface and a bottom surface (313) parallel to the emitting surface. The incident surface maintains an oblique angle relative to the bottom surface. The light source is near the incident surface of the light guide plate for radiating light beams toward the light guide plate. The optical conversion device is disposed between the light source and the light incident surface, which is configured for transforming a polarization state of some of the light beams received from the light source such that the transformed light beams can enter the light guide plate through the incident surface.

### BACKGROUND OF THE INVENTION

1. Field of the Invention

The present invention relates to a backlight module typically used in a liquid crystal display (LCD), and particularly to a backlight module having an optical conversion device configured to provide uniform illumination.

2. Background

In general, LCDs have two main advantages in comparison with cathode ray tubes (CRTs): LCDs are thin, and have low power consumption. It has been said that LCDs might one day completely replace CRT display devices, and LCDs have aroused great interest in many industries in recent times. In general, an LCD needs a backlight module to provide even light for a clear display.

A typical backlight module includes a light source and a light guide plate. The light source may be a linear light source, or one or more point light sources. The light guide plate has an end face through which light is introduced, and two opposite major faces one of which functions as an emission face. The performance of the backlight module greatly depends on the characteristics of the light guide plate employed therein.

The light guide plate functions to change a direction of propagation of light beams emitted from the light source and introduced into the light guide plate, from a direction roughly parallel to the emission face of the light guide plate to a direction perpendicular to the emission face. That is, the light guide plate effectively changes the linear or point light source(s) into a planar light source, for evenly illuminating a whole display screen of the LCD.

FIG. 4 shows a conventional backlight module 1, which includes a light guide plate 11 and two point light sources 12. The point light sources 12 are disposed adjacent to an incident surface 111 of the light guide plate 11. In use, light beams from the point light sources 12 enter the light guide plate 11 through the incident surface 111, and then emit through an emitting surface 112 of the light guide plate 11 which adjoins the incident surface 111. The emitted light beams illuminate a whole display screen of an associated LCD.

However, each point light source 12 emits light beams over a limited predetermined range of angles, and the light beams enter the light guide plate 11 with an uneven distribution. As a result, dark areas 13 are created in the light guide plate 11. The luminance of the dark areas 13 is less than that of a remaining main area of the light guide plate 11. The backlight module 1 does not provide uniformity of light beams exiting therefrom.

FIG. 5 shows an essential optical transmitting path from one of the point light sources 12 to the light guide plate 11. Generally, light beams from the light source 12 include an S-polarized light component and a P-polarized light component. The S-polarized light component has an electrical field with a direction orthogonal to the light incident surface 111, and the P-polarized light has an electrical field with a direction parallel to the light incident surface 111. When light beams from the point light source 12 enter the incident surface 111 at a Brewster's incident angle, the S-polarized light component is reflected by the incident surface 111 and the P-polarized light component is refracted into the light guide plate 11 because the two oscillation directions of the S-polarized light component and the P-polarized light component are orthogonal to each other. That is, the backlight module 1 has a low optical energy utilization ratio, which can be less than fifty percent.

A new backlight module having a light guide plate which can overcome the above-mentioned disadvantages are desired.

### SUMMARY

An example backlight module includes a light guide plate, a light source and an optical conversion device. The light guide plate includes an incident surface, an emitting surface adjacent to the incident surface and a bottom surface parallel to the emitting surface. The incident surface maintains an oblique angle relative to the bottom surface. The light source is near the incident surface of the light guide plate for radiating light beams toward the light guide plate. The optical conversion device is disposed between the light source and the light incident surface, which is configured for transforming a polarization state of some of the light beams received from the light source such that the transformed light beams can enter the light guide plate through the incident surface.

Other objects, advantages and novel features of the invention will become more apparent from the following detailed description when taken in conjunction with the accompanying drawings. In the drawings, all the views are schematic.

### BRIEF DESCRIPTION OF THE DRAWINGS

FIG. 1 is a top plan view of a backlight module in accordance with a first embodiment of the present invention, the backlight module including a light guide plate, with essential optical paths also being shown.

FIG. 2 is a side plan view of the light guide plate of FIG. 1.

FIG. 3 is a top plan view of a backlight module in accordance with a second embodiment of the present invention, showing essential optical paths thereof.

FIG. 4 is a top plan view of a conventional backlight module, showing essential optical paths thereof.

FIG. 5 is a side plan view of the backlight module of FIG. 4, showing other aspects of essential optical paths thereof.

### DETAILED DESCRIPTION OF THE PREFERRED EMBODIMENTS

Hereinafter, preferred embodiments of the present invention will be described in detail with reference to the accompanying drawings.

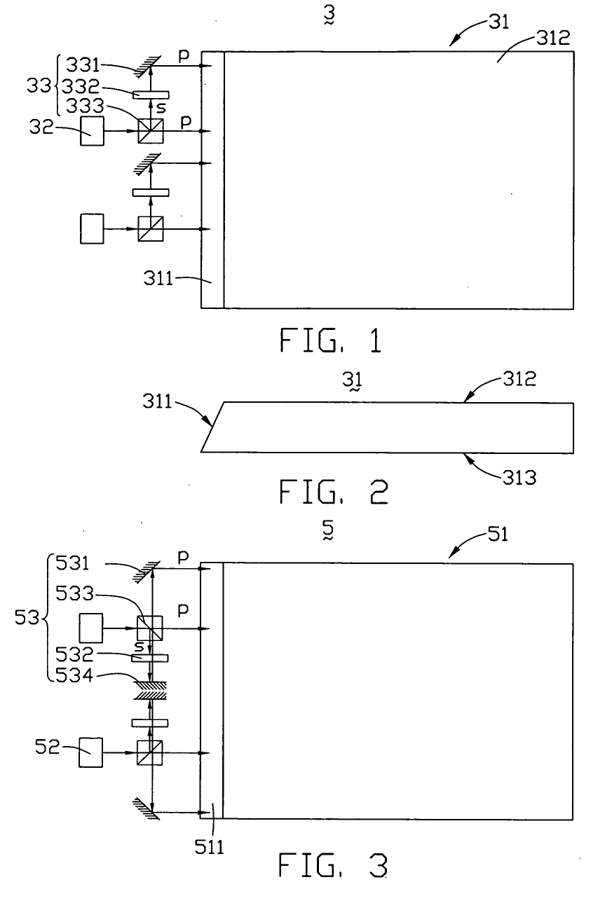

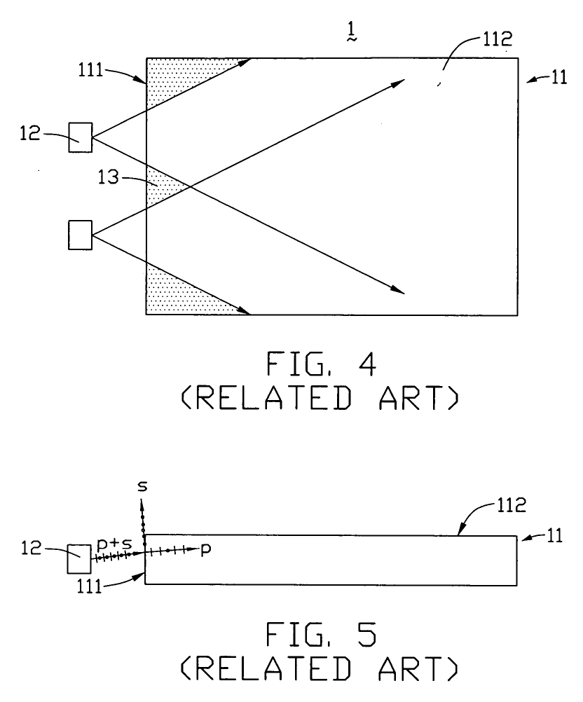

As shown in FIG. 1, a backlight module 3 in accordance with a first embodiment of the present invention includes a light guide plate 31, two light sources 32 disposed near one end of the light guide plate 31, and two optical conversion devices 33. The optical conversion devices 33 correspond to the light sources 32, and are located between the light sources 32 respectively and the end of the light guide plate 31. Each light source 32 is a point light source such as an LED (light emitting diode). The light source 32 emits light beams into the corresponding optical conversion device 33, and thereafter components of the light beams propagate into the light guide plate 31.

Referring to FIG. 2, the light guide plate 31 defines a light emitting surface 312, a light incident surface 311 adjoining the light emitting surface 312, and a bottom surface 313 opposite to the light emitting surface 312. The light incident surface 311 is an inclined surface, which maintains a Brewster's angle relative to the bottom surface 313, the Brewster's angle corresponding to incident light. The light guide plate 2 is generally made from transparent glass or synthetic resin. Various kinds of highly transparent synthetic resins may be used, such as acrylic resin, polycarbonate resin, vinyl chloride resin, etc.

Each optical conversion device 33 has a reflector 331, a half-wave retarder 332 and a beam splitter 333. The reflector 331, the half-wave retarder 332 and the beam splitter 333 are sequentially aligned along an axis that is parallel to the light incident surface 311. The beam splitter 333 faces the corresponding light source 32 for receiving light beams therefrom. The reflector 331 maintains an angle of 45 degrees relative to the axis of the optical conversion device 33.

In operation, light beams from each light source 32 propagate into the beam splitter 333 of the corresponding optical conversion device 33. In the exemplary embodiment, the light beams include a P-polarized light component having an electrical field with a direction parallel to an incident surface (not labeled) of the beam splitter 333, and an S-polarized light component having an electrical field with a direction perpendicular to the incident surface of the beam splitter 333. P-polarized light directly transmits through the beam splitter 333 and propagates into the light guide plate 31 through the light incident surface 311. S-polarized light is reflected into the half-wave retarder 332 by the beam splitter 333, and the half-wave retarder 332 causes the S-polarized light to undergo a λ/2 phase shift. Thus, the S-polarized light is converted to P-polarized light. Subsequently, the P-polarized light is reflected by the reflector 331 into the light guide plate 31 via the light incident surface 311. Because the reflector 331 maintains a 45 degree angle relative to the P-polarized light it receives, the optical conversion device 33 effectively changes the point light source 32 into a pair of point light sources. The two pairs of point light sources effectively provided by the backlight module 3 can avoid the creation of dark regions in the light plate 31.

In summary, the backlight module 3 utilizes the optical conversion devices 33 that convert S-polarized light into P-polarized light. In addition, because the light incident surface 311 is inclined at a Brewster's angle relative to the bottom surface 313 of the light guide plate 31, reflection of S-polarized light at the light incident surface 311 is avoided, and nearly all components of the light beams emitted from the light sources 32 enter the light guide plate 31. Thus the light energy utilization ratio of the backlight module 3 is enhanced.

Referring to FIG. 5, a backlight module according to a second embodiment of the present invention is shown. The backlight module 5 of the second embodiment has a structure similar to that of the backlight module 3 of the first embodiment, except that the backlight module 5 includes two optical conversion devices 53.

Each optical conversion device 53 has a first reflector 534, a quarter-wave retarder 532, a beam splitter 533, and a second reflector 531. The first reflector 534, the quarter-wave retarder 532, the beam splitter 533 and the second reflector 531 are sequentially aligned along an axis that is parallel to a light incident surface 511 of a light guide plate 51. The beam splitter 533 faces a corresponding one of the light sources 52. The first reflector 534 maintains an angle of 90 degrees relative to the axis of the optical conversion device 53, and the second reflector 531 maintains an angle of 45 degrees relative to the axis of the optical conversion device 53.

In operation, light beams from each light source 52 propagate into the beam splitter 533 of the corresponding optical conversion device 53. In the exemplary embodiment, the light beams include a P-polarized light component having an electrical field parallel to an incident surface (not labeled) of the beam splitter 533, and an S-polarized light component having an electrical field perpendicular to the incident surface of the beam splitter 533. P-polarized light directly transmits through the beam splitter 533 and propagates into the light guide plate 51 through the light incident surface 511 S-polarized light is reflected into the quarter-wave retarder 532 by the beam splitter 533, and the quarter-wave retarder 532 causes the S-polarized light to undergo a λ/4 phase shift. Subsequently, the phase shifted S-polarized light is reflected back to the quarter-wave retarder 532 by the first reflector 534, and the quarter-wave retarder 532 causes the phase shifted S-polarized light to undergo a further λ/4 phase shift. Thus, the S-polarized light received from the beam splitter 533 is converted to P-polarized light. Subsequently, the P-polarized light is reflected by the second reflector 531 into the light guide plate 51 via the light incident surface 511. Because the second reflector 531 maintains a 45 degree angle relative to the P-polarized light it receives, the optical conversion device 53 effectively changes the point light sources 52 into a pair of point light sources. The two pairs of point light sources can avoid the creation of dark regions in the light guide plate 51. The two pairs of point light sources effectively provided by the backlight module 5 can avoid the creation of dark regions in the light guide plate 51.

In summary, the backlight module 5 utilizes the optical conversion devices 53 that convert S-polarized light into P-polarized light. In addition, because the light incident surface 511 is inclined at a Brewster's angle relative to a bottom surface (not visible) of the light guide plate 51, reflection of S-polarized light at the light incident surface 511 is avoided, and nearly all components of the light beams emitted from the light sources 52 enter the light guide plate 51. Thus the light energy utilization ratio of the backlight module 5 is enhanced.

In alternative embodiments, the light sources 32, 52 can be replaced by one or more linear light sources such as one or more cold cathode fluorescent lamps. Additionally, instead of employing two light sources 32, 52, one, three or more light sources 32, 52 can be employed according to need.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

We claim:

1. A backlight module comprising:
a light guide plate defining an incident surface, an emitting surface adjacent to the incident surface, and a bottom surface parallel to the emitting surface, wherein the incident surface maintains an oblique angle relative to the bottom surface;
a light source near the incident surface of the light guide plate for radiating light beams toward the light guide plate; and
an optical conversion device between the light source and the light incident surface, the optical conversion device configured for transforming a polarization state of some of the light beams received from the light source such that the transformed light beams can enter the light guide plate through the incident surface.

2. The backlight module of claim 1, wherein the incident surface maintains a Brewster's angle relative to the bottom surface.

3. The backlight module of claim 2, wherein the optical conversion device transforms the polarization state of the light beams.

4. The backlight module of claim 2, wherein the optical conversion device transforms S-polarized light beams to P-polarized light beams.

5. The backlight module of claim 2, wherein the optical conversion device comprises a reflector, a half-wave retarder, and a beam splitter, which are sequentially aligned along an axis.

6. The backlight module of claim 5, wherein the beam splitter faces the light source.

7. The backlight module of claim 5, wherein the beam splitter is configured to allow direct transmission of P-polarized light therethrough, and to reflect S-polarized light to the half-wave retarder.

8. The backlight module of claim 5, wherein the half-wave retarder is configured to cause light beams transmitting therethrough to undergo a λ/2 phase shift.

9. The backlight module of claim 5, wherein the reflector maintains a 45 degree angle relative to the axis.

10. The backlight module of claim 5, wherein light beams from the light source propagate into the beam splitter, a P-polarized component of the light beams in the beam splitter transmits through the beam splitter and propagates into the light guide plate via the light incident surface, an S-polarized component of the light beams in the beam splitter is reflected by the beam splitter to the half-wave retarder, the half-wave retarder converts the S-polarized light to P-polarized light, and the reflector reflects the converted P-polarized light such that the converted P-polarized light propagates into the light guide plate via the light incident surface.

11. The backlight module of claim 2, wherein the optical conversion device comprises a first reflector, a quarter-wave retarder, a beam splitter, and a second reflector, which are sequentially aligned along an axis.

12. The backlight module of claim 11, wherein the beam splitter faces the light source.

13. The backlight module of claim 11, wherein the first reflector maintains a 90 degree angle relative to the axis, and the second reflector maintains a 45 degree angle relative to the axis.

14. The backlight module of claim 11, wherein the beam splitter is configured to allow direct transmission of P-polarized light therethrough, and to reflect S-polarized light to the quarter-wave retarder.

15. The backlight module of claim 11, wherein the quarter-wave retarder is configured to cause light beams transmitting therethrough to undergo a λ/4 phase shift.

16. The backlight module of claim 11, wherein light beams from the light source propagate into the beam splitter, a P-polarized component of the light beams in the beam splitter transmits through the beam splitter and propagates into the light guide plate via the light incident surface, an S-polarized light component of the light beams in the beam splitter is reflected by the beam splitter to the quarter-wave retarder, the quarter-wave retarder causes the light beams to undergo a λ/4 phase shift, the phase shifted light beams are reflected back to the quarter-wave retarder by the first reflector, the quarter-wave retarder causes the phase shifted light beams to undergo a further λ/4 phase shift such that the phase shifted light beams are transformed to P-polarized light, and the second reflector reflects the transformed P-polarized light such that the converted P-polarized light propagates into the light guide plate via the light incident surface.

17. A backlight module comprising:
a light guide plate defining an incident surface;
a light source located beside said incident surface and emitting light beams toward the incident surface; and
an optical device located between the light source and the incident surface;
wherein
said optical device includes a beam splitter to divide the light beam into two components, both of which eventually hit the incident surface while at least one of which indirectly hits the incident surface via at least one reflection.

18. The backlight module as claimed in claim 17, wherein one of said components is an S-polarized light and the other is a P-polarized light.

19. The backlight module as claimed in claim 18, wherein said S-polarized light is further converted to the P-polarized light before hits the incident surface.
